(19) United States
(12) Patent Application Publication
(10) Pub. No.: US 2014/0214598 A1
(43) Pub. Date: Jul. 31, 2014

(54) Completing A Purchase Transaction And Delivering Items

(71) Applicant: WAL-MART STORES, INC., Bentonville, AR (US)

(72) Inventors: Joel Bennett Acker, JR., Brush Prairie, WA (US); Douglas James Pedley, Portland, OR (US); Richard Neil Cancro, Portland, OR (US)

(73) Assignee: Wal-Mart Stores, Inc., Bentonville, AR (US)

(21) Appl. No.: 13/754,681

(22) Filed: Jan. 30, 2013

(51) Int. Cl. G06Q 30/06

(52) U.S. Cl. CPC G06Q 30/0633
USPC 705/26.8

(57) ABSTRACT

Embodiments for completing a purchase transaction without a customer having to move or touch an item within a retail store are disclosed. The embodiments include generating a shopping list of items the customer desires to purchase via scanning identifiers associated with the items, waypoints of the items, and a checkout waypoint to deliver the items.

### BACKGROUND INFORMATION

1. Field of the Disclosure

The present disclosure relates generally to completing a purchase transaction. In particular, example embodiments describe techniques to assist a customer obtain and deliver items.

2. Background

A customer may visit retail stores, supermarkets, and superstores, to shop for items such as clothes, groceries, office supplies, household wares, and/or to purchase services. Typically, a customer may traverse the aisles of the retail store and place items to purchase within a shopping cart. Upon gathering all the items that the customer desires to purchase within a shopping cart, the customer proceeds to a checkout counter to complete the transaction and purchase the items.

With this traditional process, customers may be burdened with lifting or moving items into a shopping cart. Yet, a customer may not be able to place the desired retail item into a shopping cart.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1A depicts an example embodiment of a computing device in communication with a point of sale server via a network.

FIG. 1B depicts an example embodiment of a computing device in communication with a point of sale server and a kiosk via a network.

FIG. 2A depicts an example embodiment of components of a computing device.

FIG. 2B depicts an example embodiment of a graphical user interface of a computing device.

FIG. 3 depicts an example embodiment of example components of a point of sale server.

FIG. 4 depicts an example embodiment of a graphical user interface including item waypoints.

FIG. 5 depicts an example method for completing a purchase transaction associated with a retail store.

Corresponding reference characters indicate corresponding components throughout the several views of the drawings. It should be appreciated that elements in the figures are illustrated for simplicity and clarity and have not necessarily been drawn to scale. For example, the dimensions of some of the elements in the figures may be exaggerated relative to other elements to help improve understanding of various embodiments of the present disclosure. Further, common but well-understood elements that are useful or necessary in a commercially feasible embodiment are often not depicted in order to facilitate a less obstructed view of the various embodiments of the present disclosure.

### DETAILED DESCRIPTION

In the following description, numerous and specific details are set forth in order to provide a thorough understanding of the present invention. It will be apparent, however, that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it should be appreciated that the figures provided herewith are for explanation purposes that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

The flowchart and block diagrams in the diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Embodiments disclosed herein are directed towards customers shopping more efficiently within a retail store. As used herein, the term “retail store” may refer to any business or a combination of businesses that sells and/or offers to sell products, and/or services to a customer. While within the retail store the customer may desire to purchase an item. As used herein, the term “item” may refer to groceries, foods, office supplies, clothing wares, or any other fungible goods sold by the retail store. However, situations may arise where elderly, disabled, young customers, etc. are unable to lift items and place the items into a shopping cart. In embodiments, disclosed herein, the customer may complete a purchase transaction without placing any items into a physical shopping cart. If the customer desires to purchase an item, the customer may scan or obtain an image for an identifier, such as a bar code or any type of identifier, associated with the desired item via a computing device without placing the item in a shopping cart. This process may be repeated until the customer has scanned identifiers associated with each item the customer desires to purchase. The customer may transmit a notification from the computing device including the customer's waypoint, the desired items, and/or the waypoint of the items the customer desires to purchase to a computing device for an associate of the retail store. The computing device may present the information associated with the notification to the associate of the retail store.

In response to being presented with the data within the notification, the associate of the retail store may gather items and deliver the items to the customer at the customer's waypoint. Therefore, embodiments disclosed herein assist a customer who may have trouble placing items within the shopping cart to complete a purchase transaction.

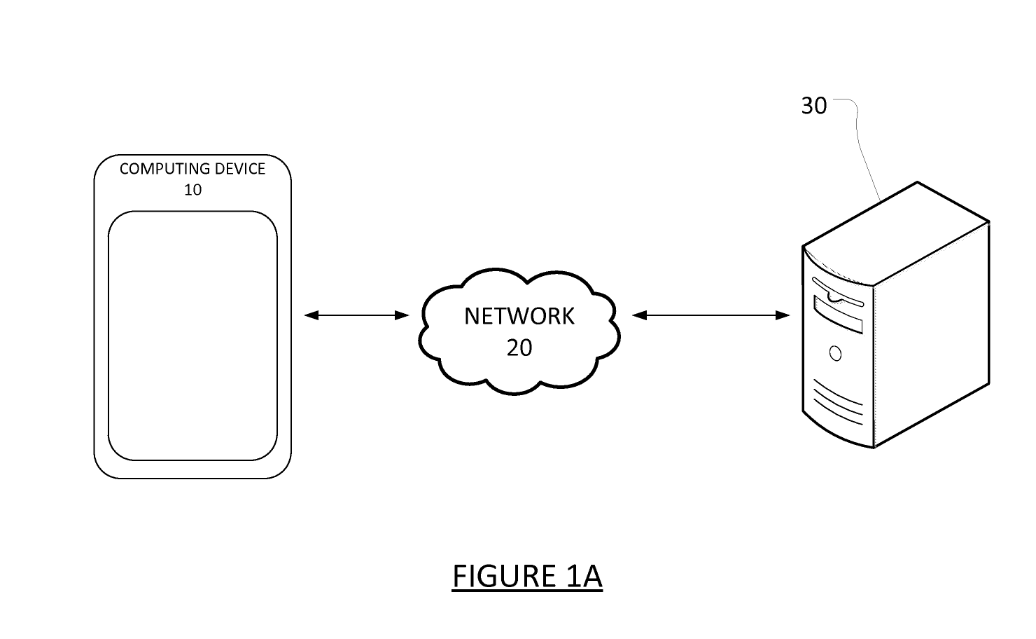

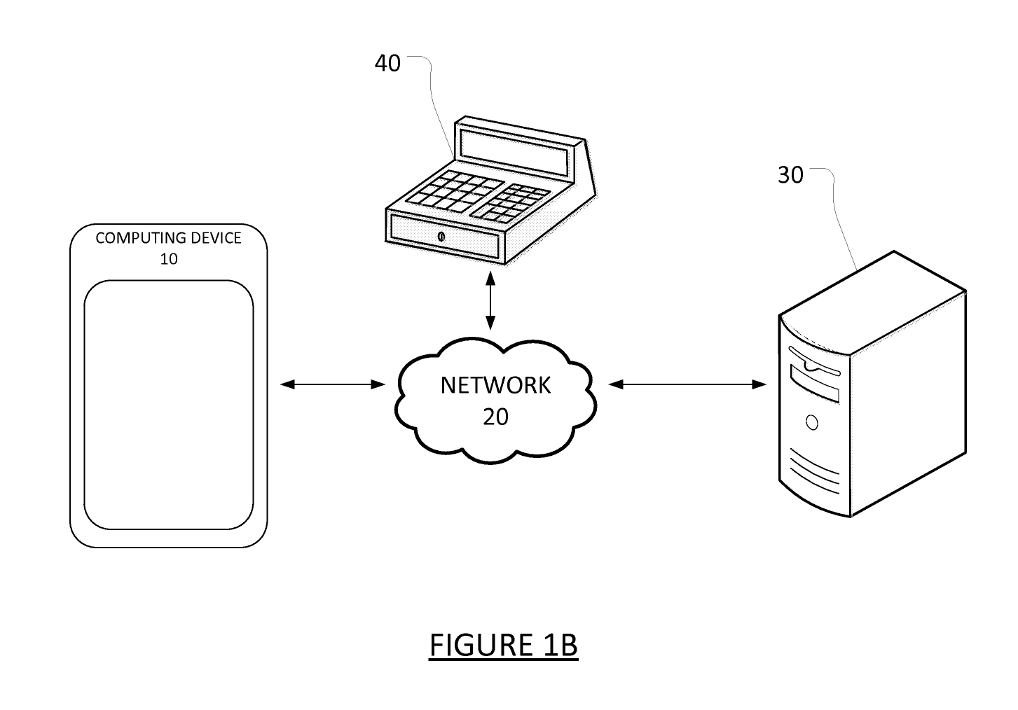

Referring now to FIG. 1A, a computing device 10 in communication with a point of sale (POS) server 30 via a network 20 is depicted.

Network 20 may be a wired or wireless network such as the Internet, an intranet, a LAN, a WAN, a cellular network or another type of network. It will be understood that network 20 may be a combination of multiple different kinds of wired or wireless networks.

POS server 30 may be a computing device such as a general hardware platform server that is capable of supporting mobile applications, software, and the like executing on computing device 10. POS server 30 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). POS server 30 may include any combination of one or more computer-usable or computer-readable media. For example, POS server 30 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Computing device 10 may be a smart phone, tablet computer, laptop computer, personal data assistant or any other type of mobile device with a hardware processor that is configured to process instructions and connect to network 20, one or more portions of network 20 and/or POS server 30 that may assist in completing a purchase transaction. Computing device 10 may be configured to scan or obtain images of identifiers, such as bar codes, associated with items that the customer desires to purchase within the retail store. In response to obtaining identifiers associated with items, computing device 10 may generate a shopping list. In embodiments, the shopping list may include further information about the item, such as a waypoint of the item within the retail store. As used herein the term “waypoint” refers generally to a location in a retail store, e.g., a location of a product or an entrance. A waypoint may be represented in geographic coordinates, Cartesian coordinates, e.g., an (x, y) point if the store is divided into a Cartesian plane, and/or may be represented using reference points, e.g., “aisle 4, 50 feet from the front of the retail store.” Computing device 10 may also be configured to determine a waypoint of computing device 10 to determine the location of the customer. The customer may interact with computing device 10 to transmit a notification including the shopping list and the waypoint of computing device 10 to POS server 30.

Referring now to FIG. 1B, a computing device 10 in communication with a point of sale (POS) server 30 and kiosk 40 via a network 20 is depicted.

Kiosk 40 may be a computing device including a processor to assist the customer in completing a purchase transaction. Kiosk 40 may store data associated with items carried by the retail store locally and/or retrieve data associated with the items from server 30 over network 20. Kiosk 40 may present an identifier associated with the item that the customer desires to purchase. Kiosk 40 may include an interactive display where the customer may select items the customer desires to purchase. In response to kiosk 40 presenting the identifier to the customer, the customer may utilize computing device 10 to scan or otherwise obtain the identifier of the item. Computing device 10 may then store the identifier within a database entry on a memory of computing device 10. This process may be repeated to generate a shopping list comprised of items that the customer desires to purchase. The identifiers associated with the items on the shopping list may be collectively stored within the database entry. In embodiments, the shopping list may include further information about each item on the list, such as a waypoint of each item within the retail store.

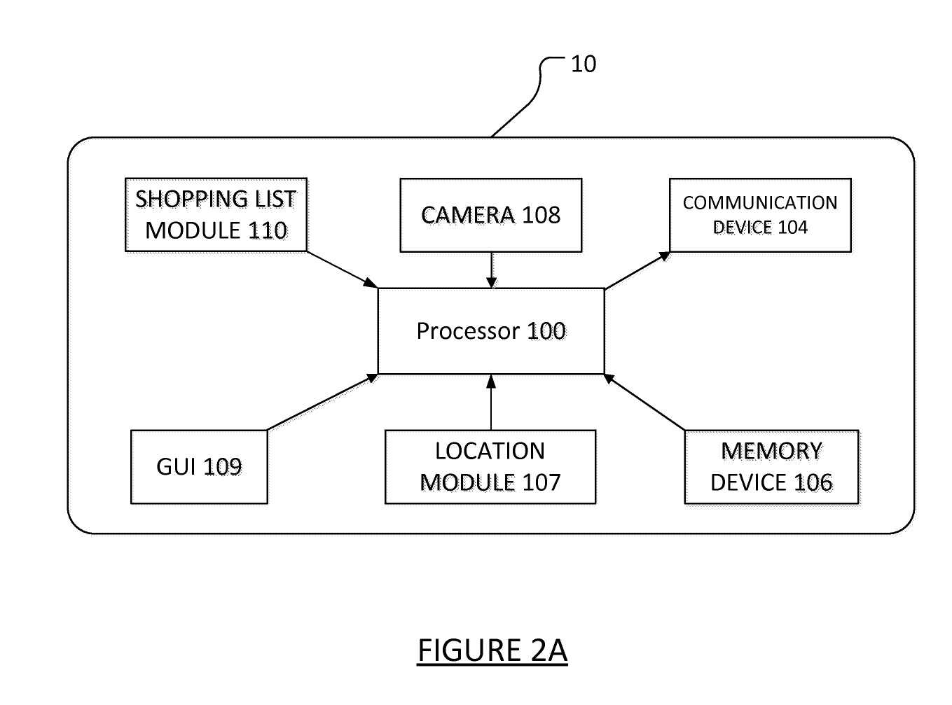

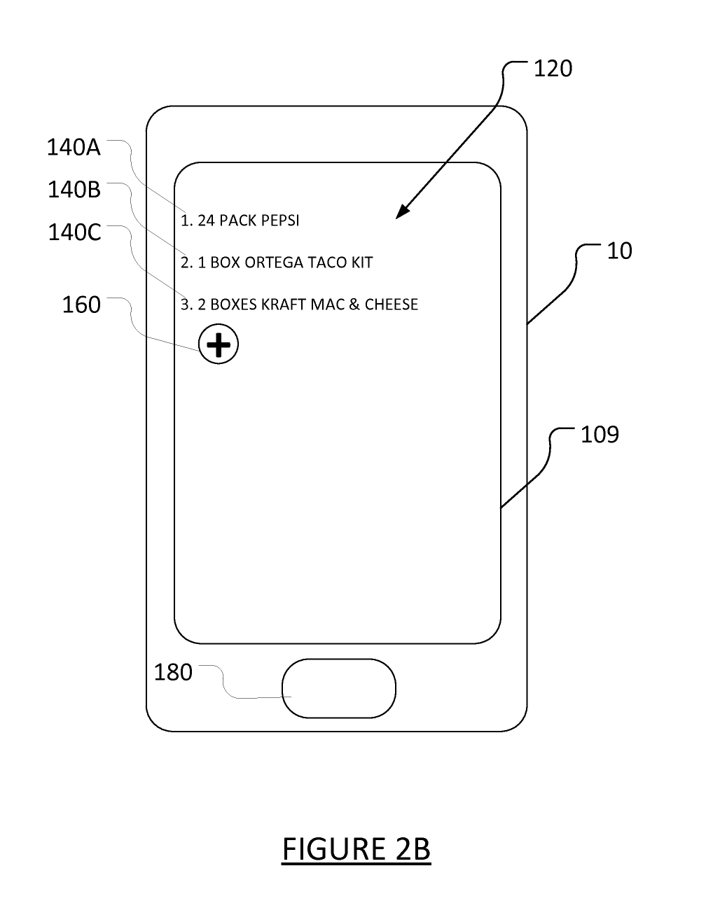

FIG. 2A depicts an embodiment of a block diagram depicting example components of computing device 10. As shown in the illustrative example, computing device 10 includes a processing device 100, a communication device 104, a memory device 106, location module 107, camera 108, graphical user interface (GUI) 109, and shopping list module 110.

Processing device 100 can include memory, e.g., read only memory (ROM) and random access memory (RAM), storing processor-executable instructions and one or more processors that execute the processor-executable instructions. In embodiments where processing device 100 includes two or more processors, the processors may operate in a parallel or distributed manner. Processing device 100 may execute an operating system of computing device 10 or software associated with other elements of computing device 10.

Communication device 104 is a device that allows the computing device 10 to communicate with another device, e.g., the POS server 30, via the network 20. Communication device 104 can include one or more wireless transceivers for performing wireless communication and/or one or more communication ports for performing wired communication. Memory device 106 is a device that stores data generated or received by the computing device 10. Memory device 106 may include, but is not limited to a hard disc drive, an optical disc drive, and/or a flash memory drive.

Location module 107 may be configured to determine a waypoint of computing device 10. Location module 107 may be configured to transmit and/or receive wireless waypoint data to transceivers positioned within the retail store of POS server 30. The wireless waypoint data may include signals such as real-time locating system signals (RTLS), WiFi signals, GPS, Bluetooth, short range radio signals, etc. to determine the waypoint of mobile computing device 10.

Camera 108 may be any device that records images that can be stored within memory device 106 or transmitted to another location such as POS server 30 via communication device 104. Camera 108 may be but is not limited to being a device that can record still images or videos. In one embodiment, camera 108 may be configured to record images of identifiers such as a bar code, Q-code, an item, or any other identifier associated with an item.

GUI 109 is a device that allows a user to interact with computing device 10. While one GUI is shown, the term “user interface” may include, but is not limited to being, a touch screen, a physical keyboard, a mouse, a microphone, and/or a speaker. GUI 109 may include a display configured to present images to the customer on mobile computing device 10 such as a map of the retail store or items within a shopping list. GUI 109 may include inputs where the customer may insert or remove items from the shopping list. GUI 109 may also include inputs where the customer may select and/or enter a desire payment method, such as a credit card number to complete a purchase transaction.

Shopping list module 110 is embodied as processor-executable instructions stored in the memory of the processing device 100, where processing device 100 can execute shopping list module 110. Shopping list module 110 may be configured to utilize camera 108 to receive identifiers associated with items that a customer desires to purchase. In embodiments, the identifier associated with the items may be bar codes, Q-codes or any other known type of identifier correlating the item with an entry in a database associated with the item. The identifiers may collectively define a shopping list of items that the customer desires to complete a purchase transaction for. The customer operating computing device 10 may navigate through a retail store and scan identifiers associated with items that the customer desires to purchase via camera 108. In response to scanning an identifier associated with an item, the item and the waypoint of the item may be added to the shopping list. Therefore, the customer may generate a shopping list of items that the customer desires to purchase while in the retail store without placing any of the items within a shopping cart. Accordingly, items that the customer is unable to lift, carry, move, etc. and/or placed in a physical shopping cart may be purchased by the customer.

In response to the customer completing a shopping list within the retail store, the customer may press an input on GUI 109 to transmit a notification including the shopping list to POS server 30 via network 20. Additionally, in embodiments, the notification may include a checkout waypoint where the customer desires the items within the shopping list to be delivered. The checkout waypoint may be determine in response to the customer pressing an input on GUI 109 to determine a current waypoint of computing device 10 or to the customer selecting waypoints from a pull down menu, free form typing, etc. The checkout waypoint may be a current waypoint of the customer, such as a waypoint within a parking lot or exit of the retail store. For example, GUI 109 may present the following selections from the customer to choose from as the checkout location “Garage A-4,” “Parking Lot,” “North Exit,” “Customer Service,” or any other waypoint associated with the retail store that the customer may desire the items within the shopping list to be delivered to.

Communication device 104 may transmit the notification including shopping list and checkout waypoint to POS server 30. In response to communication device 104 transmitting the notification to POS server 30, an associate of the retail store may be presented with data indicating the waypoint of each item on a computing device, retrieve each item for the customer, complete a purchase transaction for the items within the shopping list, and/or deliver the items to the customer at the checkout waypoint.

In other embodiments, the customers may visit a kiosk instead of or in addition to the customer navigating the retail store. The customer may visit the kiosk to scan or obtain identifiers and waypoints associated with items that the customer desires to purchase. The kiosk may include a graphical user interface where the customer may select items that the customer desires to purchase. In embodiments, in response to the customer adding an item to the shopping list from the kiosk, the kiosk may transmit data to computing device 10 associated with the waypoint of the item within the retail store. Computing device 10 may then add the waypoint data for the item to an entry in the database associated with the shopping list.

FIG. 2B depicts a display of a shopping list 120 including the items that the customer desires to purchase presented on GUI 109. Shopping list 120 includes items selected by the customer via computing device 10, e.g., item 140A, item 140B, and item 140C. Further, a field 160 allows the customer to scan additional identifiers of items to add additional items to shopping list 120. When the customer presses field 160, the customer is provided with an opportunity to add another item by taking a picture of an identifier for an item, by manually entering text of the name of the product, or by any other mechanism identifying the item. In the example, the customer has added a first item 140A indicating a 24 pack of PEPSI®, a second item 140B indicating an ORTEGA® taco kit, and a third item 140C indicating a box of KRAFT MAC & CHEESE® to the shopping list. In response to the customer adding a new item to the shopping list, computing device 10 may determine a waypoint of the customer within the retail store to determine an item waypoint associated with the location of the item within the retail store. The item waypoint may be added to a corresponding entry for the item within the shopping list.

If the customer has finished generating the shopping list and is at a waypoint that the customer desires the items within the shopping list to be delivered to, the customer can press, or otherwise select, button 180. If the customer selects button 180, computing device 10 may determine the checkout waypoint for the customer. In response to computing device 10 determining the checkout waypoint, computing device 10 may transmit a notification including the shopping list 120 and checkout waypoint to POS server 30.

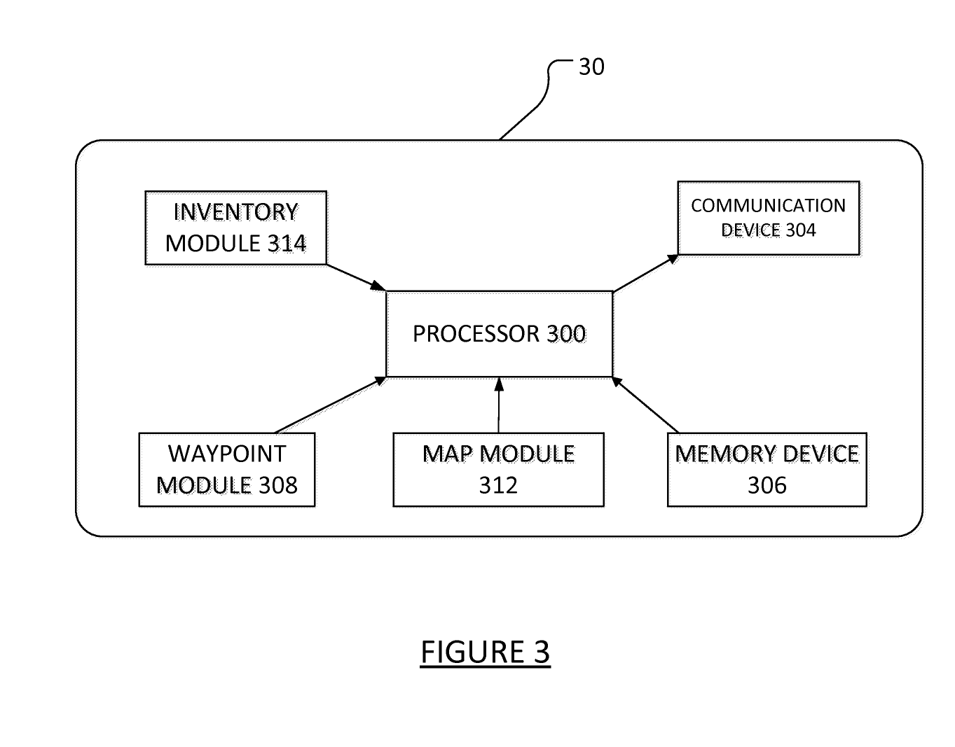

FIG. 3 depicts components of POS server 30 configured to perform one or more of the requested functions from mobile computing device 10 or kiosk 40. In the illustrated embodiment, POS server 30 may include a processing device 300, a communication device 304, a memory device 306, a waypoint module 308, a map module 312, and an inventory module 314.

Processing device 300 can include memory, e.g., read only memory (ROM) and random access memory (RAM), storing processor-executable instructions and one or more processors that execute the processor-executable instructions. In embodiments where processing device 300 includes two or more processors, the processors may operate in a parallel or distributed manner. In the illustrative embodiment, processing device 300 executes waypoint module 308, map module 312 and inventory module 314.

Communication device 304 is a device that allows POS server 30 to communicate with others device, e.g., the computing device 10 and/or kiosk 40, via network 20. Communication device 304 may include one or more wireless transceivers for performing wireless communication and/or one or more communication ports for performing wired communication.

Memory device 306 is a device that stores data generated or received by POS server 30. Memory device 306 can include, but is not limited to being a hard disc drive, an optical disc drive, and/or a flash memory drive. Further, memory device 306 may be distributed and located at multiple locations. Memory device 306 may be accessible to the processing device 300. In embodiments, memory device 306 may be configured to store information associated with waypoint module 308, map module 312, and inventory module 314. In one embodiment, memory device 306 may store waypoint data for waypoint module 308 received from computing device 10 indicating the waypoint of the customer or items within the retail store, a map of a retail store for map module 312, and identifiers and pricing information associated with items carried by the retail store for inventory module 314.

Waypoint module 308 may be configured to transmit and/or receive waypoint data identifying a location of computing device 10 and/or items within a retail store in response to the notification received from computing device 10. Waypoint data transmitted via waypoint module 308 may include an identifier, such as a star, disposed at the coordinates of items within the retail store and data associated with a map of the retail store. In embodiments, the waypoint data transmitted by waypoint module 308 may include another identifier, such as a circle disposed at the coordinates of the checkout waypoint. In embodiments, the transmitted data may be configured to present the identifiers and/or names superimposed on the map of the retail store so an associate of the retail store may readily determine the waypoints of the customer within the retail store. In other embodiments, waypoint module 308 may be configured to determine the checkout waypoint in response to the current coordinates of computing device 10. Waypoint module 308 may determine the current waypoint of computing device 10 via any known means, such as a RTLS WiFi, radar, mobile device tracking, time distance of arrival (TDOA) signals, short wave radio, Bluetooth, etc. Waypoint module 308 may perform known triangulation techniques to determine the current waypoint of the computing device 10, items within the retail store, and store data associated with the current waypoint computing device 10 in memory device 306. In one example embodiment, to determine the waypoint of computing device 10, waypoint module 308 may transmit and receive waypoint signals to transceivers positioned throughout a retail store and/or computing device 10. In response to transmitting waypoint signals to the transceivers, waypoint module 308 may receive waypoint data to determine the current waypoint of computing device 10.

Map module 312 may be configured to obtain maps corresponding to the layout of retail stores. Map module 312 may receive a map of the retail store from a plurality of sources such as the retail store, a partner of the retail store, the internet, or any other source of map information. In embodiments, map module 312 includes maps that comprise a specific layout of a retail store including product placement indicators, size of different departments, and/or an isle of the retail store.

Inventory module 314 may be configured to determine items a customer desires to purchase within the received shopping list in response to the notification received from computing device 10. Inventory module 314 may be configured to map the received identifiers to identifiers for inventory items stored within a database in memory device 306. Inventory module 314 may map the identifiers to determine which item the identifier corresponds too. Inventory module 314 may also determine a price within the database entry for each item within the shopping list. Once each identifier corresponding to the items within the shopping list and its corresponding price is determined, inventory module 314 may generate a receipt for the shopping list. Inventory module 314 may transmit the receipt for the shopping list to a point of sale to complete a purchase transaction associated with the shopping list.

In embodiments, the receipt may be transmitted along with the waypoint data, the checkout waypoint, and/or the map data to a device to be presented to an associate of the retail store. The waypoints of the items and the checkout waypoint may be presented on a display. The associate of the retail store may view the presented data, retrieve the items within the shopping list at the item waypoints, and deliver the items to the customer at the checkout waypoint. To this end, a customer may purchase items in a retail store while shopping within a physical retail store without placing any items within a physical shopping cart.

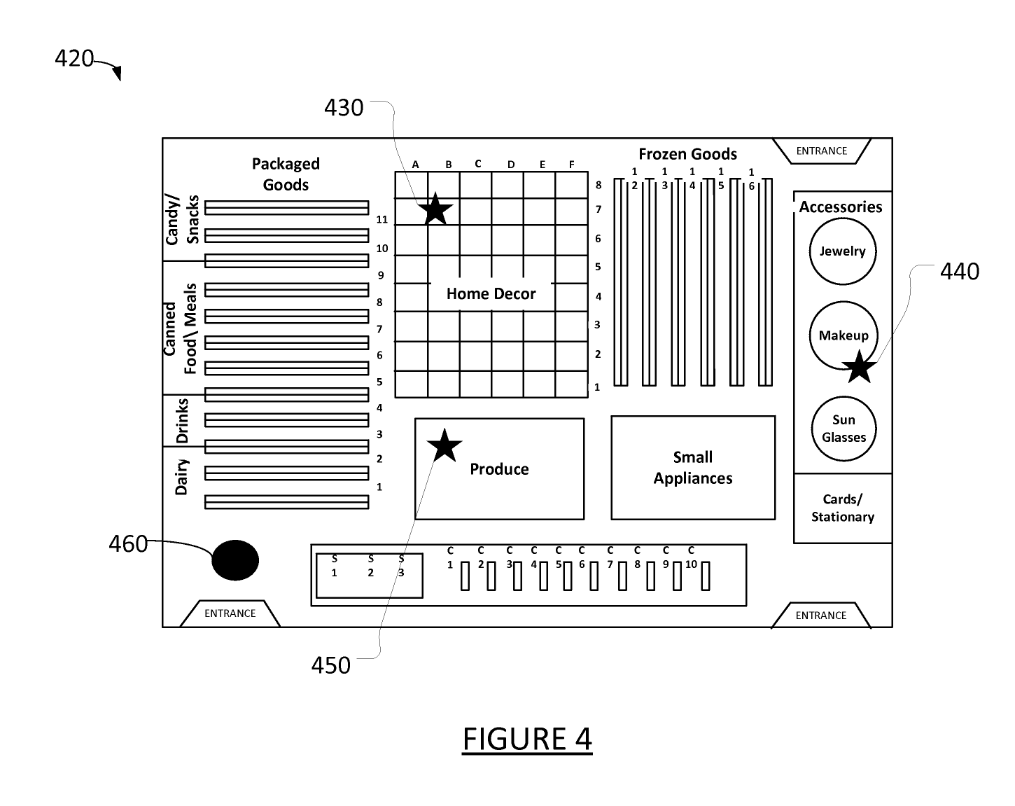

Referring now to FIG. 4, an example of a map 420 corresponding to the layout of the retail store presented to an associated of the retail store on GUI 410 is depicted. It is noted that the example map 420 is provided for example and is not limiting.

POS server 30 may transmit a notification including data associated with map 420 and waypoints 430-460 associated with a shopping list received from computing device 10. The notification may be transmitted to an associate of the retail store via a computing terminal. The computing terminal may present the data to the associate after a customer has finished generating the shopping list and selected a checkout waypoint via computing device 10.

In the illustrated example, waypoint 430 is associated with coordinates of a first item within a shopping list within the retail store, waypoint 440 is associated with coordinates of a second item within the shopping list, waypoint 450 is associated with coordinates of a third item within the shopping list, and checkout waypoint 460 is associated with coordinates where the customer desires the items within the shopping list to be delivered. As depicted, waypoints 430, 440, 450 are presented as stars superimposed on map 420 and waypoint 460 is presented as a circle superimposed on map 420. However, waypoints 430-460 may be presented in other shapes, sizes, and identifiers such as pulsating dots. Further, waypoints 430-460 may be presented in the same shape, size or identifier or different shapes, sizes or identifiers.

In response to an associate being presented data associated with the received notification from POS server 30, the associate of the retail store may determine the locations of the items in the retail store, traverse the retail store to gather the items, and deliver the items to the customer at the customer's checkout waypoint. In embodiments, before delivering the items in the shopping list to the customer at the checkout waypoint, the customer may visit a point of sale within the retail store and complete a purchase transaction for the items. The customer may complete the purchase transaction for the items via a mobile checkout device carried by the associate of the retail store at the checkout waypoint.

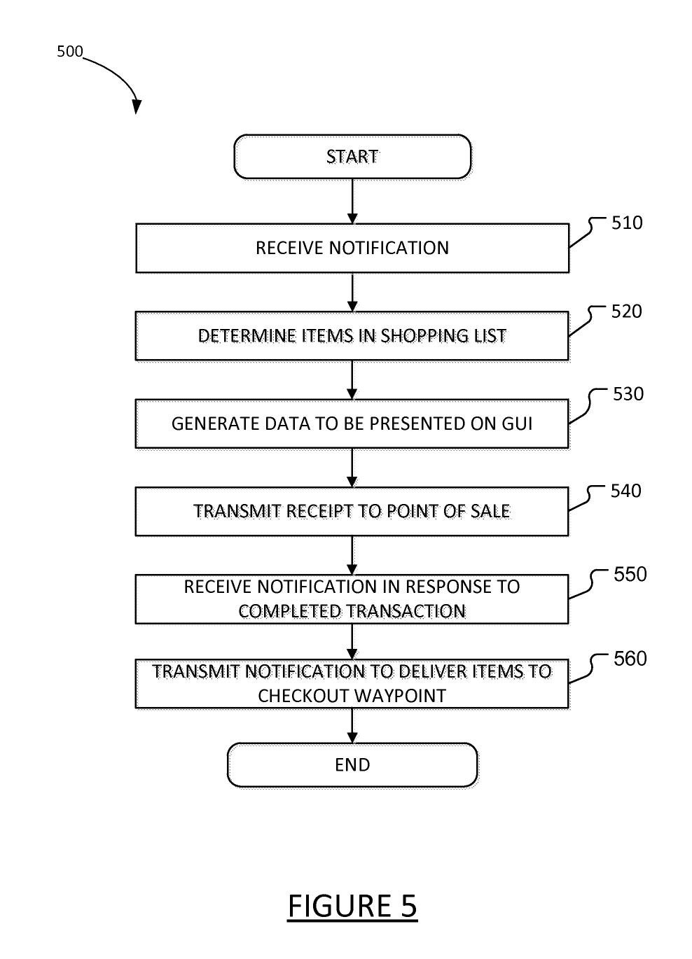

Referring now to FIG. 5, an example method 500 for completing a purchase transaction is depicted. In the illustrated example, method 500 is executed by the processing device of POS server 30. It is noted that method 500 may be modified such that it can be executed by processing device 100 of computing device 10. It is further noted, that method 500 is presented as a non-limiting example, and other embodiments steps recited in method 500 may be omitted, rearranged, and/or additional steps may be included.

At operation 510, a POS server may receive a notification of a shopping list including items that a customer desires to purchase, waypoints of the items, and a checkout waypoint. In one embodiment, the customer may generate the shopping list by scanning or obtaining identifiers of items via a camera on a computing device that the desire to purchase. Waypoints of the items may be determined via the waypoint of the computer device when the item was added to the shopping list. The waypoint of the item may be performed by known triangulation techniques or any other method. In one embodiment, the checkout waypoint may be determined as current coordinates of the computing device or coordinates selected by the customer as a location for the items within the shopping list to be delivered to.

At operation 520, the POS server may map the received identifiers associated with the items on the received shopping list with identifiers or barcodes for inventory items stored within a database to determine which item the customer desires to purchase. If the received identifier corresponds to an identifier for an inventory item, then POS server may determine that the customer desires to purchase that item.

At operation 530, the POS server may generate data to be presented on a computing terminal to an associate of the retail store. The generated data may include a map of the retail store, the waypoint of the items on the map, and the checkout waypoint. In response to viewing the presented data, an associate of the retail store may obtain the items in the shopping cart throughout the retail store.

At operation 540, the POS server may generate a receipt of the items in the shopping list and transmit the receipt to a point of sale device. In embodiments, the point of sale device may be a fixed computer terminal at a checkout counter or a mobile device. The customer may visit the point of sale device and complete a purchase transaction for the items on the shopping list.

At operation 550, the POS server may receive a notification that the purchase transaction for the items on the shopping list has been completed.

At operation 560, in response to a completed purchase transaction, POS server may transmit a notification to computing device for an associate of the retail store indicating that the associate should deliver the items on the shopping list to the checkout waypoint.

In view of the above, a customer may generate a shopping list for items while within a retail store without having to lift or move any of the items. Further, the items on the shopping list may be gathered by an associate of the retail store and transported to any desired location associated with the retail store, such as a parking lot where the customer's vehicle may be located. Therefore, customers and retail stores may experience a more efficient shopping experience.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific examples are provided for explanation purposes and that other values may also be employed in other embodiments and examples in accordance with the teachings of the present disclosure.

What is claimed is:

1. A computer-implemented method comprising:
receiving, at a processing device, a shopping list, the shopping list including a retail item and an item waypoint associated with the retail item;
generating, at the processing device, data to be presented on a graphical user interface including a map of a retail store and an item identifier at the item waypoint; and
receiving, at the processing device, a checkout waypoint including coordinates associated with the retail store where the item is to be delivered.

2. The computer-implemented method of claim 1, wherein the item waypoint can be any location within the retail store.

3. The computer-implemented method of claim 1, further comprising:
adding the item to the shopping list in response to a mobile computing device scanning an identifier associated with the item.

4. The computer implemented method of claim 3, wherein the identifier is a bar code.

5. The computer implemented method of claim 3, further comprising:
transmitting the identifier to be presented on a display.

6. The computer-implemented method of claim 3, further comprising:
determining, at the processing device, the item waypoint as coordinates of the mobile computing device in response to adding the item to the shopping list.

7. The computer implemented method of claim 1, wherein an item identifier is configured to be superimposed on the map.

8. The computer implemented method of claim 1, wherein the shopping list is dynamically generated by a mobile computing device.

9. A server comprising:
an interface configured to receive a shopping list including a retail item, an item waypoint associated with the retail item, and a checkout waypoint including coordinates associated with the retail store where the item is to be delivered; and a
a processor configured to generate data to be presented on a graphical user interface including a map of the retail store, an item identifier at the item waypoint, and the checkout waypoint.

10. The server of claim 9, wherein the item waypoint can be any location within the retail store.

11. The server of claim 9, wherein the processor is configured to add the item to the shopping list in response to a mobile computing device scanning an identifier associated with the item.

12. The server of claim 11, wherein the interface is configured to transmit the identifier to be presented on a display.

13. The server of claim 11, wherein the processor is further configured to determine the item waypoint as coordinates of the mobile computing device in response to adding the item to the shopping list.

14. The server of claim 13, wherein the identifier is a bar code.

15. The server of claim 11, wherein the item identifier is configured to be superimposed on the map.

16. The server of claim 9, wherein the shopping list is dynamically generated by a mobile computing device.

17. A mobile device comprising:
an imaging device configured to receive an identifier associated with an item;
a waypoint module configured to determine coordinates of the mobile computing device, wherein the waypoint module determines the coordinates of the mobile computing device in response to receiving the identifier associated with the item and coordinates to deliver the item; and
a transmitter configured to transmit the identifier and the coordinates of the mobile computing device.

18. The mobile device of claim 17, wherein the waypoint can be any location within the retail store.

19. The mobile device of claim 17, further comprising:
a graphical user interface to add the item to a shopping list by scanning the identifier associated with the item.

20. The mobile device of claim 19, wherein the shopping list is dynamically generated by the mobile device at a retail store.
